(19) United States
(12) Patent Application Publication
(10) Pub. No.: US 2008/0200168 A1
(43) Pub. Date: Aug. 21, 2008

(54) METHOD AND SYSTEM FOR SEAMLESS DATA ROAMING ACROSS MULTIPLE OPERATOR BEARERS

(76) Inventor: John Yue Jun Jiang, Danville, CA (US)

Correspondence Address: ARENT FOX LLP, 1050 CONNECTICUT AVENUE, N.W., SUITE 400, WASHINGTON, DC, 20036, US

(21) Appl. No.: 12/015,472

(22) Filed: Jan. 16, 2008

Related U.S. Application Data
(63) Continuation-in-part of application No. 10/635,804, filed on Aug. 5, 2003, now Pat. No. 7,072,651.
(60) Provisional application No. 60/880,386, filed on Jan. 16, 2007.
(60) Provisional application No. 60/924,525, filed on May 18, 2007.

(51) Int. Cl. H04Q 7/20

(52) U.S. Cl. 455/432.1

(57) ABSTRACT

A system and method for seamless data roaming across multiple operator bearers is provided. The system allows a client device to seamlessly select most preferred available operator bearer without losing a data session. It also allows the server to control dynamically both the operator preference list on the client and the data usage across multiple operator bearers.

### RELATED APPLICATIONS

This application claims the benefit of U.S. Provisional Application No. 60/880,386 titled “A Transparent Seamless Roaming Service for Automatic Switching Among Different Bearers of a Wireless Access Device Without Losing Session Data” filed Jan. 16, 2007. This application also claims the benefit of U.S. Provisional Application No. 60/924,525 titled “Real Time Roaming Data Exchange Service” filed May 18, 2007, and is a continuation-in-part of U.S. patent application Ser. No. 10/635,804 titled “Method And System For Cellular Network Traffic Redirection” filed Aug. 5, 2003, now U.S. Pat. No. 7,072,651. The entirety of each of the aforementioned related patent applications is incorporated by reference herein.

### BACKGROUND OF THE INVENTION

1. Field of the Invention

The present invention relates to the field of mobile telecommunications, and more particularly, to a system and method for seamless data roaming of a subscriber device across multiple operator bearers.

2. Description of the Related Art

Handset clients and device-on-chip solutions that enable mobile or other low-power, digital telecommunications transception using a number of different physical-layer bearers have been available in mobile phones for several years. An example of such solutions is Broadcom's® “Cellularity” chip, released as early as 2003 in the first Palm® Treo™ and other devices that integrate GSM/CDMA, so-called “3G” physical layers (WCDMA or EVDO), “WiFi” (802.11x protocol communications), “WiMAX,” and “Bluetooth” for near field communications.

For users, the experience of switching between physical layers while communicating with such devices is intended, in the state of the art, to be “seamless,” meaning that the user would be unaware of which physical layer is being used for the user's communications. The device itself would choose the most convenient communications method, based on the signal strength.

Hence, many of these multiple-physical-layer devices (like the new Apple® iPhone) often offer some type of automatic capability that, in theory, permits the user to engage in telecommunications activity in a manner that is independent of the physical transmission method that the device uses. For example, an Apple® iPhone user browsing the Internet ideally does not even become aware of when the Google maps session, which the user initiated at home on a WiFi network, switches to an Edge session when the user walks out of the house.

However, provisioning these data services by the least-cost-path requires taking into account much more information than that available at the client, such as signal strength or location.

These days, different operators offer different bearer services. For example, in the United States, Clearwire® offers WiMAX service, Sprint® offers EVDO and WiMAX services and AT&T® offers HSDPA, EDGE, 3G and GPRS services. Of the public WiFi services, many subscribe to T-Mobile for use at Starbucks coffee shops, while subscribing to entirely different carriers for 3G or mobile service. Therefore, a local subscriber may maintain accounts with a number of different carriers for providing various physical transmission services—a cable operator for home Internet and WiFi service, a mobile operator for handset data and voice service, a public WiFi provider for digital device use at WiFi “hotspots,” city-wide services for public WiFi (e.g., offered in various cities by Earthlink®), and Clearwire® or Sprint® for WiMAX high-speed Internet access where available. Enterprises may maintain a number of high-volume subscriptions for each enterprise's mobile workforce. Adding to the complexity is that some of these carriers do not offer “all-inclusive” access, but charge according to the amount of data downloaded during each subscription period.

When a user is roaming outside of the user's service areas, either for mobile phone or WiFi hotspot use, the problem of determining the least-cost-path becomes even more complex. In fact, “roaming” outside of a coverage area for any of these physical transmission services depends upon the efficiency of the service provider to enter into numerous bilateral roaming agreements, accounting, and billing relationships necessary to make the roaming coverage low-cost and available on-demand.

Although the client-side technology for enabling “seamless” transfer of physical communications from one bearer method to another has existed for some time, and although a client can make decisions, based purely on location and signal strength, to determine the most powerful transception means, relying on these two data points only would result in absurd commercial decisions for users and operators alike. Users would regularly exceed the data usage limits provided by their subscription plans, incurring large overuse charges. Operators would be exposed to significant collection and customer satisfaction issues, should they attempt to charge customers automatically without advising customers of those charges up front.

At the same time, because users often choose a variety of carriers for the different transmission types, and often roam geographically between coverage areas, carriers themselves, even if they entered an infinite number of bilateral roaming agreements with other carriers, would not, by themselves, possess the correct information about user-preferences in real time, in order to make least-cost-path decisions on their users' behalf to provide the needed digital communications most efficiently.

The commercial problems surrounding seamless data roaming are exacerbated by the fact that many types of communications, especially secure “VPN” type of communications, and peer-to-peer download communications require the maintenance of a persistent IP address or a persistent user identification—persistence, which would be interrupted each time a user's device switches physical bearers.

Therefore, there is a need in the art for a for a client-server infrastructure that functions beyond the individual device level to maintain persistent identification. There is a further need in the art for a for a client-server infrastructure that functions beyond the purview of a single operator, which can store and make available all of a user's relevant subscription, location, data-usage, signal strength and other information required to make automatic and fully-informed decisions in providing “seamless” transitions between physical transmissions methods in order to provide mobile communications users with the least-cost communications means at all times. Such an infrastructure should be able to receive and synthesize updated subscription information from the various operators, as well as updated preference information from users, in order to make those least-cost-path calculations. Such an infrastructure should be centrally controlled for security, but distributed enough to render convenient, efficient service.

### SUMMARY OF THE INVENTION

Accordingly, it is an object of the present invention to provide a system and method for seamless data roaming that provides customers automatic switching to the most preferred operator bearer without losing a data session.

It is another object of the present invention to provide a system and method for seamless data roaming that controls the subscriber data usage across multiple operator bearers.

It is another object of the present invention to provide a system and method for seamless data roaming that enables transparent VPN access without losing sessions when IP address and operator bearer is changing.

It is another object of the present invention to provide a system and method for seamless data roaming that permits seamless roaming without requiring the operators to engage in a huge number of commercial agreements.

It is another object of the present invention to provide a system and method for seamless data roaming that provides dynamic download of updated operator bearer preferences.

It is another object of the present invention to provide a system and method for seamless data roaming that supports peer-to-peer design philosophy.

The above, and other objects of the present invention are achieved by providing a system and a method for seamless data roaming across multiple operator bearers.

In accordance with an embodiment of the present invention, the system includes a client that is installed on a subscriber device for interfacing with a plurality of operator bearers and selecting a first bearer from the plurality of operator bearers based on a pre-specified preference list, wherein the operator bearer preference list is dynamically obtained by the client. Further, the system includes a server architecture consisting of at least one login server for initiating a data session upon receiving a login request from the client, a plurality of super nodes for communicating on behalf of the client, and at least one central redirection server for dynamically providing the client with an operator bearer preference list, when the subscriber communication device enters a new operator network.

All bearers are treated as independent with respect to operators. The system for seamless data roaming is completely transparent to the bearers (fixed or wireless) and their operators. There is no involvement of inter-standard roaming technologies. There is no need for new standard and protocols in the radio access networks. Individual bearers can have their own security access information that need only be configured once by the client. There is no need for any special network infrastructure elements in the operators of the accessing bearers. All seamless handling can be operated on top of an IP protocol. Although there will not be a single bill in this approach, it is consistent with the general industry trend that GSM/CDMA data access and WiFi access generally have separate authentication mechanisms and separate bills.

The client switches to a new bearer either because of the availability of a more preferred bearer, or the loss of the current bearer. The system can be integrated with a data traffic redirection service, in which the client will be dynamically downloaded with an operator bearer preference list based on the territory/network bearer used each time a territory is entered, so as to cause the client to select a most preferred bearer available that may be different from the accessing bearer. The preference can be dynamically controlled by the server based on its current application logic. When the switching takes place, data buffers up at both the client device and the network side. The Internet (including enterprise) access is proxied between an on-device client and a server infrastructure on the network side. The session data will be maintained across switching of different bearers at the client and server.

The transparent seamless roaming service can also be integrated with a peer-to-peer infrastructure to facilitate faster download of a piece of content, support multimedia content download, scheduled off-peak downloads and the like. It allows the client to integrate various parts of a download package from different data sources, as is required by state-of-the-art peer-to-peer distribution means, such as publicly available services based on the BitTorrent protocol, or commercial peer-to-peer services such as Limelight. The transparent seamless roaming service also allows the server to coordinate common downloads to support each other for faster download of Internet and enterprise content.

Further, the system for seamless data roaming provides a multi-operator preference management at the network side that steers roamers traffic to the right operator bearer based on a dynamic update of client operator bearer preference. The solution is hosted outside any individual operator since a user can have different operator services. Also, the solution can be hosted inside an operator if the intended customers use only that operator's services. A hybrid model is also possible, so that for example, by bilateral agreements, an operator can host a seamless roaming system and make it available to users as well as other operators who also offer different physical transmission services to the hosting operator's subscribers. The hosting operator optionally could agree to provide that access to non-hosting operators in exchange for those other operators reciprocating by providing access to their own seamless roaming servers.

Further, the system for seamless data roaming provides a multi-operator data service control at the network side to control the usage of a subscriber across multiple operator bearers. Instead of putting or relying on any data service control solution inside an operator, the service controls multiple operator data usage at the network side completely independent of operator technologies. In particular, a data service control is applied within a peer to peer architecture where master-slave architecture is proposed. This allows a client to communicate with a master server which controls several slave servers to coordinate the download of various parts of a particular content. Namely, the seamless roaming infrastructure under the present invention would maintain a track of how much data a user has consumed under each of his operator plans, and use that information in making least-cost-path decisions in providing the user with seamless interworking between physical layers.

Further, the system for seamless data roaming with the server centrally hosted can be run independent of operators, although partnerships with operators can also be established that provide controls and data steering for subscribers of these operators that support these operator bearer preferences. Enterprises with large mobile workforces might obtain unusual benefit from the seamless roaming infrastructure of the current invention, due to the scale and impact of their setting the correct preferences for physical transmission choice. The business model by which a provider of service under the present invention could be monthly subscription fee or completely ad-driven. When it is ad-driven, the client can also display ads pushed to the client (or pulled by the client) with the content matching the subscriber profile. The profile will be dynamically refined based on subscriber clicking through the ads as well. The client server service with the server centrally hosted can also be run in partnership with operators. Each joining operator can offer its own subscribers a preference in selecting bearers of its own network and of roaming partners of the joining operator. The service, with the help of a subscriber client, can also dynamically mediate conflicting preferences between different operator bearers of different roaming partners of different joining operators.

In addition to making least-cost-path decision in an automatic way, based on subscription, usage, location, and signal strength variables, a seamless roaming infrastructure service under the present invention can also alert a user to choices. It can alert a user to an anticipated switch in transmission methods and advise the user of anticipated charges, and provide the user choices such as terminating the communications session, continuing the communications session under a different physical bearer, remaining in the coverage area of the present bearer, or provide a choice of new bearers if more than one is available.

### BRIEF DESCRIPTION OF THE DRAWINGS

FIG. 1 is a diagram of the system for seamless data roaming across multiple operator bearers, in accordance with an embodiment of the present invention.

FIG. 2 is a diagram of a data flow of a data communication session for seamless roaming across multiple operator bearers, in accordance with an embodiment of the present invention.

FIG. 3 is a diagram of a flow of data redirection for seamless roaming across multiple operator bearers, in accordance with an embodiment of the present invention.

FIG. 4 is a diagram of integration architecture of peer-to-peer service within the system for seamless data roaming across multiple operator bearers, in accordance with an embodiment of the present invention.

FIGS. 5a and 5b are diagrams of a flow of data service control for seamless roaming across multiple operator bearers, in accordance with an embodiment of the present invention.

FIG. 6 is a diagram of a flow of data alert service for seamless data roaming across multiple operator bearers, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the particular system and method for seamless data roaming across multiple operator bearers in accordance with an embodiment of the present invention, it should be observed that the present invention resides primarily in combinations of system components and method steps related to seamless data roaming.

Accordingly, the system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

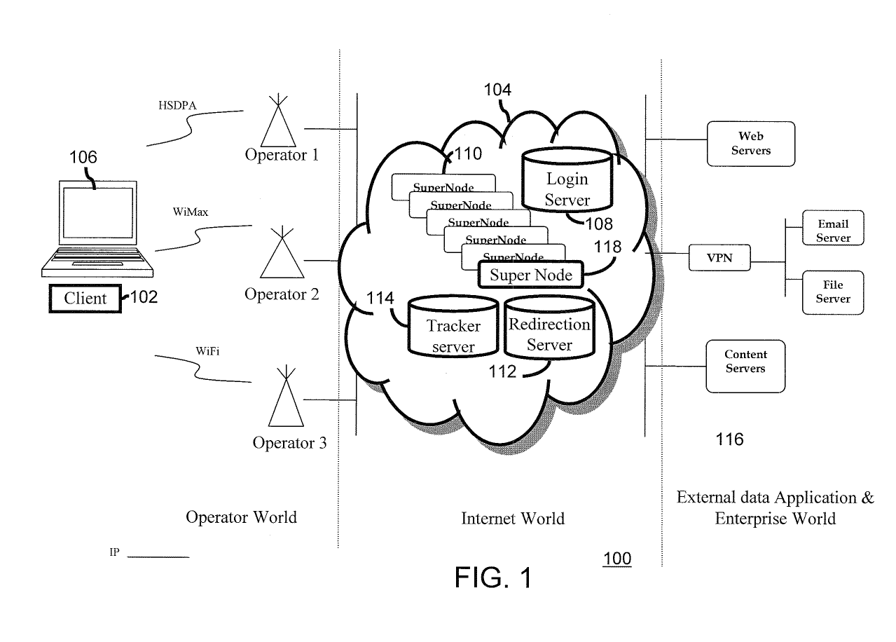

FIG. 1 is a diagram of the system 100 for seamless data roaming across multiple operator bearers, in accordance with an embodiment of the present invention. The system 100 is essentially a Client and Server Architecture that operates on top of the IP protocol with access to external data application and enterprise services. The system 100 includes a client 102 and server architecture 104.

The client 102 is installed on a subscriber communication device 104. Examples of the subscriber communication device 104 include, but are not limited to, computers, set-top boxes, smart phones, Personal Digital Assistants (PDA), cellular phones, game consoles and mobile game devices, and laptop computers. The client 102 is capable of being used to configure and receive preferences of operator bearers, user or enterprise preferences such as when to utilize available WiFi or user or enterprise-provided physical transmission, and secure authentication and access information for bearer and enterprises. Different operator bearers can have their own security access data, which need only be configured once. Any of the preferences, regardless of source, can be updated on-demand or dynamically as changes are instituted.

The subscriber communication device 104 can support various data access bearers or communications with multiple subscriptions from possibly different operators. Examples of the data access bearers include, but are not limited to, WiFi, WiMAX, CDMA EVDO, 3GSM, HSDPA, Ethernet, and Local Area Network (LAN). The client 102 interfaces the different access bearers to periodically scan available networks.

The operator bearer preferences can be controlled by a subscriber, the enterprises in which the user takes part, or the operator bearers, and updated dynamically with the server. When a subscriber is currently on a bearer, the client 102 also continues to look for a more preferred bearer based on all of the relevant variables including without limitation, location, signal strength, cost, present type of use (For example, voice, download, email, web and the like), and overall use when subscription plans are based on pay-per-use. If the current bearer either is lost, or ceases to be the optimal bearer, then the server can invoke the device to switch to the more optimal bearer. Each time the client 102 seeks a new bearer, it will start from the most preferred bearer first.

The server infrastructure 104 consists of a plurality of super nodes 110, at least one login server 108, at least one redirection server 112. In an embodiment of the present invention, the system also includes at least one tracker server 114. The client 102 will be configured to access a login Server 108. The login server 108 is capable of initiating a data session with at least one external data server 116 on receiving a login request from the client. Examples of the at least one external data server 116 include, but are not limited to, Internet, email, web. Voice-over-IP (VOIP) service (such as Vonage or Skype) and Virtual Private Network (VPN).

In an embodiment of the present invention, a plurality of login servers can be used. The client 102 starts a bootstrapping process with the initial login server 108 to dynamically obtain the list of login servers out of which a less loaded one can be selected. This helps in distributing load on the plurality of login servers.

Once bootstrapping is done, each new data session with an external data server 116 starts off with authentication with a login server 108. Once the client 102 has obtained a bearer channel, it starts off a login session using a TCP/IP protocol with the login server 108. The client 102 passes network access information (For example, network, territory, country, and bearer), last login-server used and subscriber identity information to the login server 108 for authentication. The login server 108 obtains the subscriber information from the last login server it used.

The login server 108 is capable of performing AAA (Authentication, Accounting, and Authorization) functions. The login server 108 selects a super node 118 from the plurality of super nodes 110 based on some application logic and assigns a session ID to the client 102. In addition to access control, the login server 108 can also store subscriber profile, last usage and threshold information, and last network/territory where an operator bearer preference has downloaded to the client.

Once authenticated, the login server 108 checks if the current territory is the same as the territory of the last download of operator bearer preferences. If it is not, it consults the redirection server 112 to send down an operator bearer preference list to the client 102 so the client 102 can select the most preferred bearer available. In an embodiment of the present invention, the client 102 passes on the subscriber information such as last allowed data usage, session ID and threshold information to the super node 118 that has been assigned by the login server 108 to work with the client 102.

Once the client 102 is granted access with a session ID and the super node 118 and possibly a new list of operator bearer preferences, it can then select the most preferred bearer available according to the list unless that is already selected prior to the list download. The client 102 then communicates through the super node 118.

The client 102 communicates with the super node 118 via a reliable protocol. Examples of the protocol include, but are not limited to, reliable UDP and TCP protocol. Both the client 102 and the super node 118 have sufficient memory to buffer a session between the client 102 and the super node 118. Unless acknowledged for the receipt of a packet, the packet is kept for retransfer. There will be a configurable timeout for the drop of the packet. Different buffer size, time out and retransmit mechanism can be defined for the client 102 and the server 104.

In an embodiment of the present invention, the client 102 changes IP address as it changes a bearer. Normally without the super node 118, certain types of communications session that depend upon maintaining a persistent IP address (such as a VPN session with the VPN server, a VOIP session, or a peer-to-peer or subscription download session) will break since the session provider will continue to require the original IP address. However the super node 118 maintains, on a “proxy basis” from the beginning of the session, communication of an original, persistent IP address, so the session-provider would continue under the impression that the IP address remained fixed. The client 102 and the super node 118 encapsulate all original IP packets within the tunnel/proxy addresses of the client 102 and super node address. The original packets itself could tunnel further address information such as VPN. Thus, the client 102 and super node tunnel allow the client IP address to change.

For IP packets sent by a client 102, the super node 118 replaces the source address by the (previously assigned if assigned) super node address and the port number and the destination address by the originally encapsulated destination address. For IP packets sent by a network application, the source address is replaced by the (previously assigned if assigned) super node address and the port number and destination address by the client address and port. The plurality of super nodes 110 is transparent to the IP packet content or application data. The client 102 can have a private IP address. However a super node will most likely be a public IP address although it is possible to be private if an operator group offers the seamless roaming service, or if the super node is provisioned with the ability to instantiate IP addresses. When the client 102 is accessing Internet or enterprise, public IP address will be mapped from the private IP address via NAT or NAPT. Since different bearers of different operators can assign a different IP address to the subscriber communication device 106 when it is switching bearers, the super node 118 re-maps the new client IP address for data transfer proxies through the super node 118.

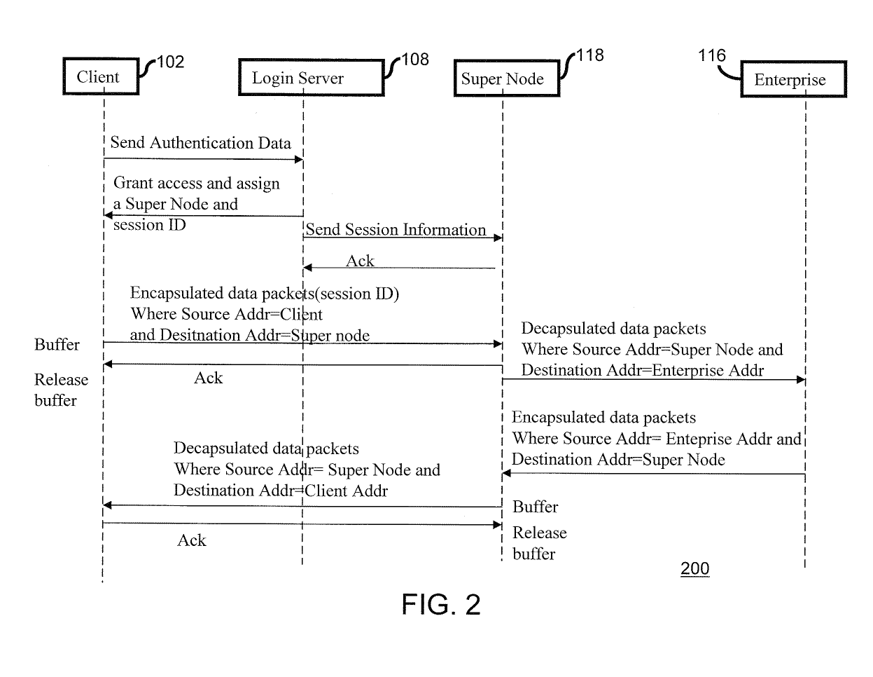

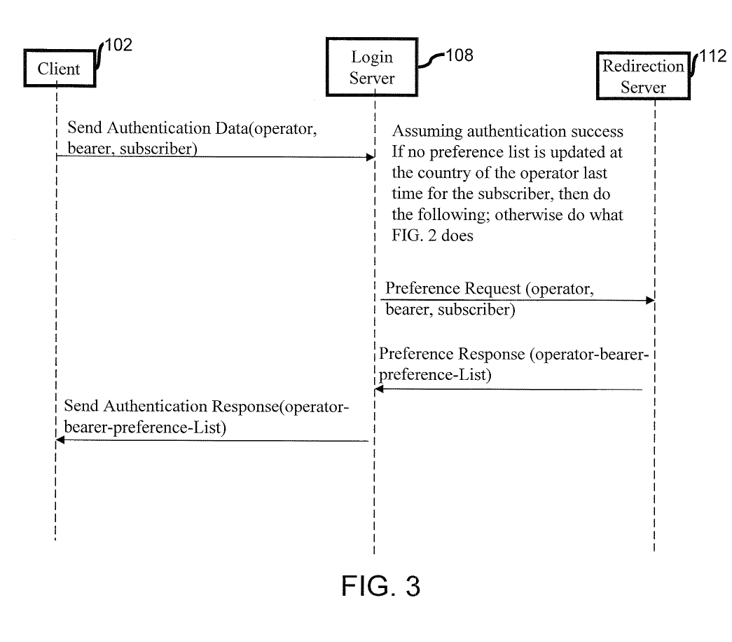

FIG. 2 is a diagram of a data flow of a data communication session for seamless roaming across multiple operator bearers, in accordance with an embodiment of the present invention. The client 102 sends a login request with information like network access information (For example, network, territory, country and bearer), last login-server used and subscriber identity information to the login server 108 for authentication. The login server 108 receives the request and authenticates the client data. Further, the login server 108 assigns a super node 118 from a plurality of super nodes 110 to the client 102. The login server 108 assigns a session ID to the client 102 and sends the session information to the super node 118. For IP packets sent by a client 102, the super node 118 replaces the source address by the (previously assigned if assigned) super node address and the port number and the destination address by the originally encapsulated destination address. For IP packets sent by a network application, the source address is replaced by the (previously assigned if assigned) super node address and the port number and destination address by the client address and port.

FIG. 3 is a diagram of a flow of data redirection for seamless roaming across multiple operator bearers, in accordance with an embodiment of the present invention. The client 102 sends a login request with information like network access information (For example, network, territory and bearer), last login-server used and subscriber identity information to the login server 108 for authentication. The login server 108 receives the request and authenticates the client data. Once authenticated, the login server 108 checks if the current territory is the same as the territory of the last download of operator bearer preferences. If it is not the same, it consults the redirection server 112 and sends a new operator bearer preference list to the client 102 so that the client 102 can select the most preferred bearer available. Once the client 102 is granted access with a session ID and the super node 118 and possibly a new list of operator bearer preferences, it then selects the most preferred bearer available according to the list unless that is already selected prior to the list download. The client 102 then communicates through the super node 118.

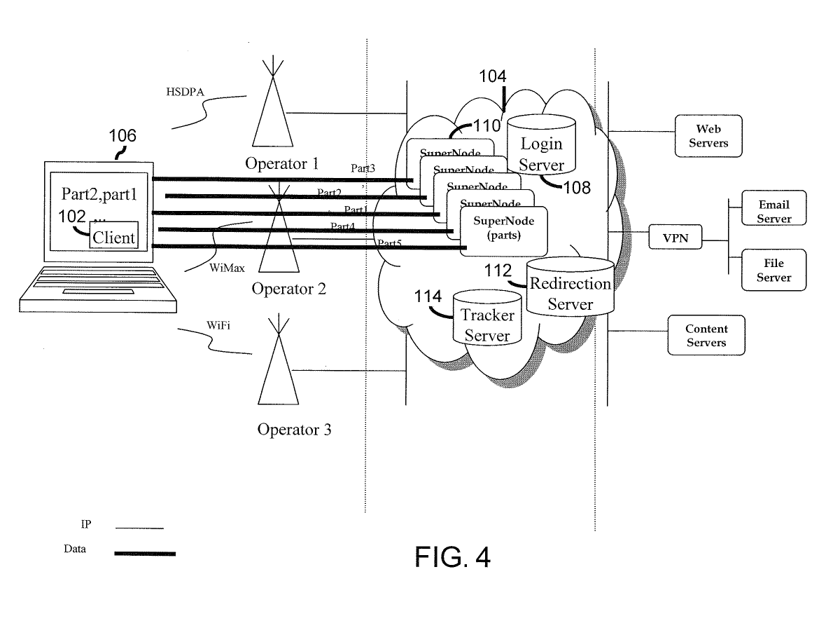

FIG. 4 is a diagram of integration architecture of peer-to-peer service within the system 100 for seamless data roaming across multiple operator bearers, in accordance with an embodiment of the present invention. The super node 118 is configured with a peer-to-peer architecture 402 for accessing Internet multimedia contents. When combined with such a peer-to-peer architecture 402, both the client 102 and the super node 118 are capable of acting as a server to facilitate upload of downloaded information to other peer parties (a client or a super node). The subscriber is provided with an option of specifying the type of multimedia content to grant permissions for such a peer to peer service. For example, music downloads, movie downloads, video downloads and the like. When the client 102 acts as a server, it is treated like a dynamically created pseudo temporary super node.

In an embodiment of the present invention, the client 102 has a capability to integrate different parts of download of the same package at different times to facilitate faster downloads. The super node 118 plays the peer-to-peer support in download and upload on the network side. The client 102 however is capable of getting the parts downloaded by the super node 118 to itself as soon as the super node 118 downloads it.

The plurality of super nodes 110 can be distributed around the world. They themselves can also apply a peer-to-peer architecture 402 so as to help each other in completing common download among themselves, maintaining persistent session data as a client device moves between bearers, and maintaining require authentication and access values for the various available bearers. The at least one Tracker server 114 maintains the directory of seed servers for data sources and for coordinating the downloaded parts among the plurality of super nodes 110 and clients.

In an embodiment of the present invention, to facilitate even faster downloads, the client 102 directly switches to different super nodes dynamically whenever a super node has a part of the total download available. A current super node of the client 102 interfaces with the tracker server 114 to switch around super nodes based on Master-Slave architecture. Under this architecture, the current super node of the client 102 acts as a master node while the other nodes act as slave nodes for the client 102. The master node gets size information from various parts of a content download from the tracker server 114. It directs the client 102 to talk to the slave nodes. A client can talk to several slave nodes simultaneously in a session. A slave node informs the master node for any data usage, and download result for the content part it is responsible for.

In an embodiment of the present invention, the system 100 supports push services, provided by the least-cost-path at the most cost-efficient time and location. The client 102 periodically sends heartbeat for any data to a bypass firewall. Whenever there is data available, the heartbeat response indicates so. The client 102 then makes a request for the data. In another embodiment, the system 100 also supports off-peak downloads and scheduled downloads. The scheduled program can also be dictated via a push service.

In an embodiment of the present invention, the system 100 runs the service as an advertisement-driven business model for an enterprise or just for a particular subscriber. The subscriber profile (For example, company background, personal interest and location) can be used to push advertisement data to the subscriber communication device 106. The profile can be dynamically refined based on subscriber clicking through the advertisements. When the client 102 is behind a firewall, the client 102 will need to send a heartbeat to check for any push advertisement data so that a subsequent pull can be initiated. The amount of advertisements sent to the client 102 can be a percentage control of the total data sent across the client-server path or proportional to the buffering at the client and at the server side.

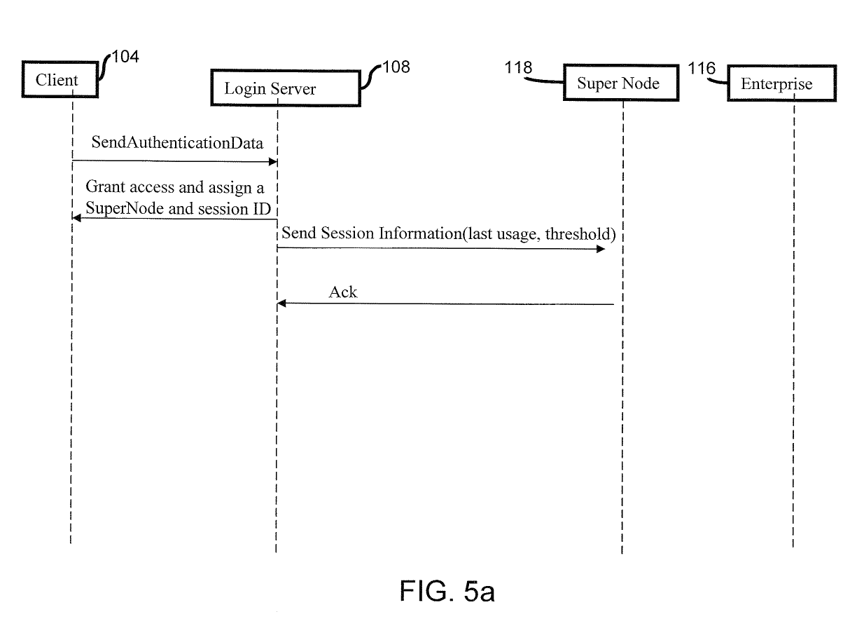

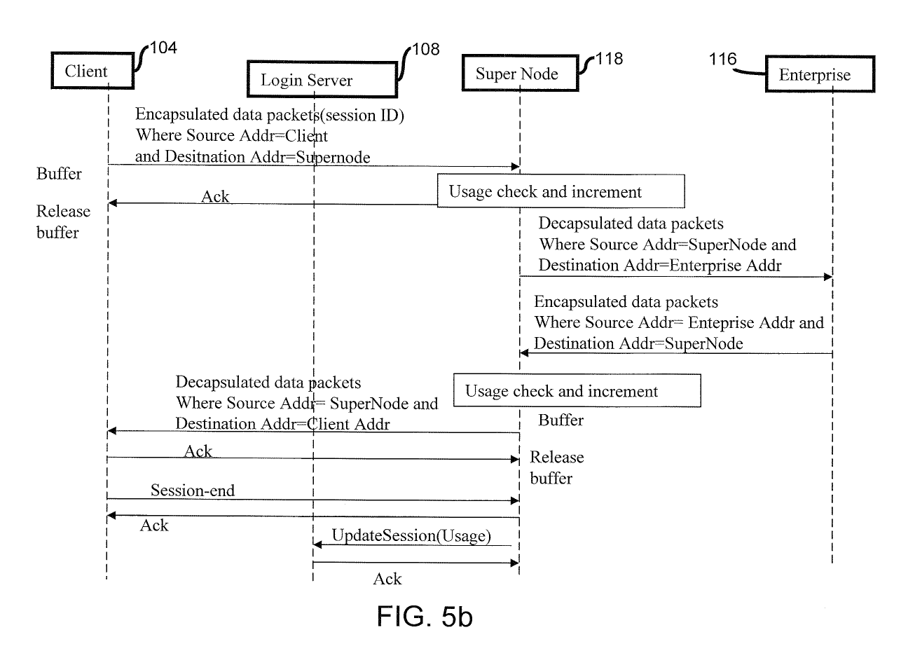

FIGS. 5a and 5b is a diagram of a flow of data service control for seamless roaming across multiple operator bearers, in accordance with an embodiment of the present invention. As shown in the figure, the super node 118 records the usage and collects data intelligence for data passing through it. The data intelligence can include, but is not limited to, subscriber usage behavior, usage errors, usage pattern and statistics. For example, which site a subscriber usually goes to, the reason a subscriber cannot access a site, is it because the subscriber enters the URL wrongly and the like. Any time, the data usage of a subscriber exceeds the threshold of the subscriber, the client 102 applies some application logic to terminate the session and warn the user to get a confirmation to continue. The application logic depends on an operator bearer and a subscriber profile.

Once a session is established between the super node 118 and the client 102, the super node 118 can then measure the incoming data from client 102 and the incoming data from network application to ensure that the data service is immediately terminated or controlled once the data usage satisfies the threshold usage criteria. Whether the data session is terminated or the data session has completed, the super node 118 informs the login Server 108 about the current data usage and reasons for the data usage close. In this way, the seamless roaming infrastructure under the present invention assists the user in ensuring that he does not incur over-usage charges.

In an embodiment of the present invention, under the Master-Slave architecture for super nodes, the master node gets size information from various parts of a content download from the tracker server 114. It directs the client 102 to talk to the slave nodes. The client 102 talks to several slave nodes simultaneously in a session. The slave node informs the master node for any data usage and download result for the content part it is responsible. The master node can avoid the download of a piece of content as a whole if that will exceed the subscriber threshold by informing the user (for a smaller download) or get permission to continue. It can also do so when the next individual part of a piece of content will exceed the threshold.

Finally, the super node 118 (master only) or the login server 108 may consult the redirection server 112 at any time to dynamically download a revised operator preference list to the client 102 based on a pre-specified application logic. This allows data usage to be distributed across multiple operator bearers. The type of application logic can be based percentage weights, for example. This type of application logic would also be useful to help keep a client staying on within an operator bearer for a certain period of time before switching since some operator bearers have minimum charges associated with it irrespective of how much data is sent over the bearer.

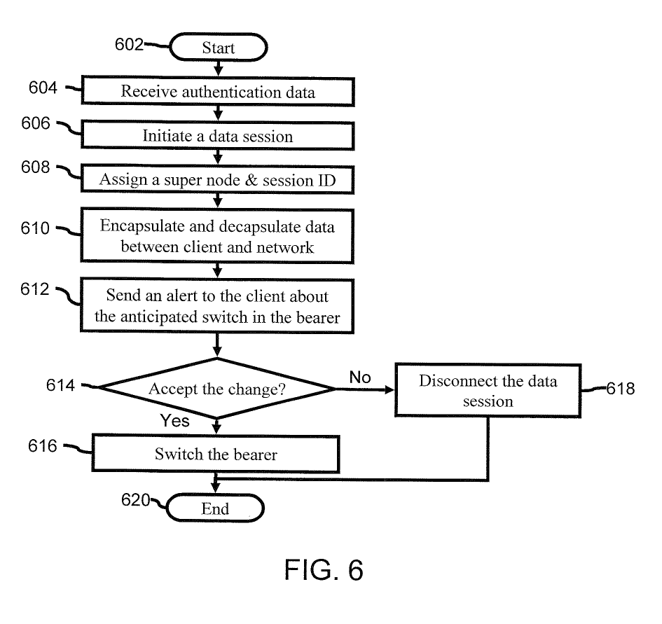

FIG. 6 is a flowchart for a method for alerting a subscriber, in accordance with an embodiment of the present invention. As shown in the flowchart, the super node 118 sends an alert to the client 102 for informing the subscriber. It can alert the subscriber to an anticipated switch in transmission methods and advise the user of anticipated charges, and provide the subscriber with choices such as terminating the communications session, continuing the communications session under a different physical bearer, remaining in the coverage area of the present bearer, or provide a choice of new bearers if more than one is available. At step 602, the process is started. At step 604, authentication data is received from the client 102 for initiating a data session. The login server 108 authenticates the client 102 and at step 606 a data session is initiated. The client 102 is assigned a super node 118 and a session ID at step 608. The super node 118 encapsulates and decapsulates the data between the client 102 and an external data server 116 at step 610. At step 612, the super node 118 sends an alert to the client 102, informing the subscriber about the anticipated switch in the operator bearer. At step 614, the subscriber is sent a request to accept or decline the change in the operator bearer. The subscriber accepts the change, and the data session is switched to a new operator bearer by the super node 118 at step 616. In another embodiment, the user declines the change request, and hence, the super node 118 disconnects the current data session at step 618. At step 620, the process is terminated.

Hence, the present system and method for seamless data roaming across multiple operator bearers provides customers automatic switching to the most preferred operator bearer without losing a data session. Also, the present invention helps in controlling the subscriber data usage across multiple operator bearers and thereby saving costs incurred to the subscriber. Further, the present invention enables transparent VPN access without losing sessions when IP address and operator bearer is changing.

Also, the present system and method for seamless data roaming does not require the operators to engage in a huge number of commercial agreements among themselves. Roaming traffic being a major percentage of an operator's revenue and even a better percentage of the operator's margin, the present invention can increase the profits of the operators because of the potential growth in data roaming.

It is well known that roaming traffic contributes a significant percentage of an operator's revenue and even a better percentage of the operator's margin. With increasing competition and regulatory control, operators are becoming more pressurized to increase roaming revenue and reduce roaming margin loss. Voice roaming, however is under greater regulation and its growth rate is slowing down. In contrast, data roaming has proved to be much more important due to its potential growth with respect to the current low utilization. Thus, selecting the right data roaming partner bearer for a roamer will improve home operator's revenue, margin and customer satisfaction. It could also reduce subscriber cost and improve the quality (For example, speed) of the data access.

Current seamless roaming solutions focus on either hand-off among different wireless bearers within the control of a single operator or inter-standard roaming among different wireless standards operated by different operators. In these solutions, a gateway control infrastructure is deployed either in the visiting operator network (For example, UMA architecture) or in the home network (For example, IMS). While the visiting network gateway infrastructure provides tighter integration at the transport level and single billing for the roamer, it requires the visiting operator's support of such a gateway network infrastructure. While the home network gateway infrastructure can work with any visiting network, maintain sessions at home network, allowing enterprise access and still support a single billing for the roamer, it requires inter-standard roaming agreement and translating technologies between visiting operators and home operators when they have different standards of networks. Furthermore, these solutions are operator dependent and require new standards and protocols.

More advanced seamless roaming solutions although addressed transparent switching between different bearers of same or different operators without any mobile operator technology changes, but did not address adequately the problems of virtual private network data access which depends on the origin's IP address (which can be changed due to the change of a bearer).

Furthermore, none of the current seamless data roaming solutions address the problem of controlling the multi-subscription operator bearer preferences from a network side from an operator or subscriber perspective, although the inventor has addressed the issue when roaming from a single home operator perspective in various issued patents [TR 2003 Jiang et al) worldwide. Since a user might subscribe to different operator services and may use different (visiting or home) network bearers, different home operators' preferences on (roaming or non-roaming situation) network bearer preferences might conflict with another. In a roaming example, a Chinese user might use a China Mobile SIM card to roam in USA where the network preference is ATT over T-mobile on EDGE bearer, but the user device could also have a WiMAX and WiFi subscription service (with their associated cards) whose home operators are China Netcom and China Telecom respectively. For China Netcom, the WiMAX preference in USA could be Sprint over Clearwire. For China Telecom, the WiFi preference could be T-mobile over ATT. A non-roaming example could be that the Chinese user in China Mobile subscription will have preferences of EDGE over GPRS; while his China Netcom WiMAX subscription could have preference of WiFi over WiMAX when China Netcom also offers WiFi; while his China Telecom subscription will favor its own WiFi.

Today, the multi-subscription operator bearer preference is relying on the client and the user configuration. It is possible to have a network solution to upgrade client operator preferences constantly, however blindly shooting for all clients who may not be even wirelessly connected will not be very cost-effective. Besides, a first time connecting client might not have the right preference of operator bearers in place. Note here that the preference is with respect to both operator and its associated bearers from a home operator perspective. That's, some operators are more preferable than other operators from a home operator perspective; more precisely some operator bearers are more preferable than same or other operators' bearers from a home operator perspective. The preference can be based on inter operator tariffs of roaming relationships with respect to a home operator.

Throw multiple home operator preferences in the mix complicate the situation even further. Throwing subscriber preferences across these different operator bearers adds further complexity. Managing these changing operator bearer preferences from different home operators and subscribers on the client side could be very challenging as a result.

Furthermore, current seamless data roaming solutions do not address the data roaming service control problems across multiple operators. These problems are concerned with the accidental over-usage of roaming data services without roamer's awareness of the potential huge roaming cost or without roamer's knowledge (because the user device is left running a TV over a mobile Internet connection). Although there are some single operator solutions for data service control, these have to rely on putting network elements inside operator networks. Furthermore, none of them address the multi-home operator issues. A roamer with an EDGE data subscription of China Mobile, a WiMAX data subscription of China Netcom, a WiFi data subscription of China Telecom might not have individual usage exceeding a usage limit, but combined could have contributed a usage threshold. A multi-home operator control will capture such cases.

Often data download might involve a peer to peer architecture where the client is interacting with several servers on different parts of a content download. However current peer to peer solutions don't deal with data service control. There is no consideration on how much data a client is allowed to download. The focus was only on efficient use of bandwidth and speed of download by distributing the data source from parts of a content download. Although data service control is achievable within the control of a single operator, however no such a control exists on a peer to peer architecture involving multiple operator bearers.

The present invention solves these problems by providing a system and a method for seamless data roaming that does not require the operators to engage in a huge number of commercial agreements among themselves. Roaming traffic being a major percentage of an operator's revenue and even a better percentage of the operator's margin, the present invention can increase the profits of the operators because of the potential growth in data roaming.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The examples under the present invention, detailed in the illustrative examples contained here, are described using terms and constructs drawn largely from GSM mobile telephony infrastructure. However, use of these examples should not be interpreted to limiting the invention to those media. The capabilities of the visited or non-accustomed network can be of use and provided through any type of telecommunications medium, including without limitation: (i) any mobile telephony network including, without limitation, GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage, Skype or Packet 8.

### Terminology

3G: Third generation of mobile

### CDMA: Code Division Multiplexed Access

EDGE: Enhanced Data rates for GSM Evolution

### EVDO: Evolution-Data Optimized

### GPRS: General Packet Radio Service

### GSM: Global System for Mobile

### HSDPA: High-Speed Downlink Packet Access

### IMS: IP Multimedia Subsystem

### IP: Internet Protocol

### NAPT: Network Address Port Translation

### NAT: Network Address Translation

### TCP/IP: Transmission Control Protocol (TCP) and the Internet Protocol (IP)

### UDP: User Datagram Protocol

### URL: Uniform Resource Locator

### VPN: Virtual Private Network

### WCDMA: Wideband Code Division Multiple Access

WiMAX: Worldwide Interoperability for Microwave Access

What is claimed is:

1. A system for seamless data roaming of a subscriber having a subscriber communication device across multiple operator bearers and operator networks, the system comprising:
a client installed on the subscriber communication device for selecting a bearer from an operator bearer preference list, wherein the operator bearer preference list is dynamically compiled by the client; and
a server infrastructure comprising:
at least one login server for initiating a data session upon receiving a login request from the client;
a plurality of super nodes for communicating on behalf of the client; and
at least one redirection server for dynamically providing the client with an updated operator bearer preference list, when the subscriber communication device enters a first operator network from a second operator network.

2. The system recited in claim 1, wherein the client configures and receives the operator bearer preference list, and secures access information for one of the multiple operator bearers.

3. The system recited in claim 1, wherein the subscriber provides an order of preference of operator bearers; wherein selecting a bearer comprises searching available bearers from the operator bearer preference list; and wherein the searching is performed based on the order of preference provided by the subscriber.

4. The system recited in claim 1, wherein the received login request from the client is for a first bearer selected from the operator bearer preference list.

5. The system recited in claim 4, wherein initiating the data session includes authenticating the client upon receiving the login request.

6. The system recited in claim 5, wherein initiating the data session further includes selecting a super node from the plurality of super nodes, the super node being selected based on pre-specified application logic.

7. The system recited in claim 6, wherein initiating the data session further includes assigning a session ID to the client.

8. The system recited in claim 1, wherein a super node of the plurality of super nodes comprises a storage memory for buffering a session between the client and the super node of the plurality of super nodes.

9. The system recited in claim 1, the server infrastructure further comprising:
at least one external data server, wherein communicating on behalf of the client includes encapsulating and decapsulating IP packets between the client and the at least one external data server.

10. The system recited in claim 1, wherein a super node of the plurality of super nodes comprises a peer-to-peer architecture for accessing and downloading Internet multimedia content.

11. The system recited in claim 1, wherein the client comprises an integrated module for facilitating faster downloads.

12. The system recited in claim 1, further comprising:
a support module for push services, wherein the push services include at least one selected from a group consisting of pushing emails, messages, calls and advertisements.

13. The system recited in claim 1, further comprising:
at least one tracker server for enabling communication among the plurality of super nodes.

14. The system recited in claim 1, further comprising:
at least one external data server, wherein the external data server includes at least one selected from a group consisting of Internet, email, web and Virtual Private Network (VPN).

15. A method for seamless data roaming of a subscriber communication device having a client installed thereon across multiple operator bearers and operator networks, the method comprising:
selecting a first bearer from a plurality of operator bearers included in a first operator bearer preference list for a first operator network;
initiating a data session with the selected first operator bearer, the data session being initiated via a connection, the connection having a connection characteristic;
assigning a super node from a network of super nodes, each super node having a super node characteristic, for communicating on behalf of the client by masking the connection characteristic with the assigned super node characteristic;
receiving a second operator bearer preference list upon entry of the subscriber communication device into a second operator network; and
switching the subscriber communication device to a selected second bearer from operators bearers included in the second operator bearer preference list;
wherein the switching is controlled by the super node, the super node maintaining the masked connection characteristic with the assigned super node characteristic; and
the switching is performed without interrupting the data session.

16. The method recited in claim 15, wherein selecting a first bearer comprises:
receiving an order of preference of operator bearers; and
searching available bearers from the first operator bearer preference list;
wherein the searching is performed based on the received order of preference of operator bearers.

17. The method recited in claim 15, wherein selecting a first bearer includes:
configuring and receiving the first operator bearer preference list; and
securing access information for the first operator bearer.

18. The method recited in claim 15, wherein initiating the data session comprises:
receiving a login request from the client, wherein the received login request from the client is for a first bearer selected from the operator bearer preference list.

19. The method as recited in claim 18, wherein initiating the data session further comprises:
authenticating the client on receiving the login request.

20. The method as recited in claim 19, wherein initiating the data session further comprises:
selecting a super node from the plurality of super nodes, the super node being selected based on pre-specified application logic.

21. The method recited in claim 15, wherein initiating the data session further comprises:
assigning a session ID to the client.
